(19) United States
(12) Patent Application Publication
(10) Pub. No.: US 2006/0228973 A1
(43) Pub. Date: Oct. 12, 2006

(54) LED Light Strings

(75) Inventor: John L. Janning, Dayton, OH (US)

Correspondence Address: DICKSTEIN SHAPIRO LLP, 1825 EYE STREET NW, Washington, DC, 20006-5403, US

(73) Assignee: JLJ, INC., Dayton, OH (US)

(21) Appl. No.: 10/908,524

(22) Filed: May 16, 2005

Related U.S. Application Data
(60) Provisional application No. 60/670,197, filed on Apr. 11, 2005.
(60) Provisional application No. 60/670,797, filed on Apr. 13, 2005.
(60) Provisional application No. 60/671,639, filed on Apr. 15, 2005.
(60) Provisional application No. 60/674,990, filed on Apr. 26, 2005.

(51) Int. Cl. H05B 33/00; H05B 33/02

(52) U.S. Cl. 445/24; 445/25

(57) ABSTRACT

Christmas or other holiday season light strings are provided with phosphorescent, after glow characteristics, where a lighting element continues to glow after the light string is turned off. A light string includes an LED lighting element with a light-conducting encapsulant coated with or otherwise containing light-storing phosphor particles. Blue and UV LED lighting elements with strontium oxide aluminate phosphor particles are described. Pigments and a light diffuser are added for even, different colored lighting.

### CROSS-REFERENCE TO RELATED APPLICATIONS

Benefit of priority is claimed based on U.S. Provisional Application No. 60/670197 filed Apr. 11, 2005; U.S. Provisional Application No. 60/670797 filed Apr. 13, 2005; U.S. Provisional Application No. 60/671639 filed Apr. 15, 2005; and U.S. Provisional Application No. 60/674990 filed Apr. 26, 2005.

### BACKGROUND

Traditional light strings have long been used for Christmas or other holiday season lighting. These have included AC driven, parallel wired, high voltage incandescent light strings, and more recently, AC or DC driven low voltage, typically series wired, incandescent mini-light and LED light strings. However, such light strings generally go dark and stop emitting light, i.e., there is no after glow, when the light string is switched off.

### SUMMARY

Christmas or other holiday season light strings are provided with phosphorescent, after glow characteristics, where a lighting element continues to glow after the light string is turned off. A light string includes an LED lighting element with a light-conducting encapsulant coated with, or otherwise containing, light-storing phosphor particles. Blue and UV LED lighting elements with strontium oxide aluminate phosphor particles are described. Pigments and a light diffuser are added for even, different colored lighting.

Additional variations, features and advantages will become apparent from the further description and claims to follow.

### BRIEF DESCRIPTION OF THE DRAWINGS

FIG. 1 depicts a Christmas tree draped with a light string.

FIG. 2 shows an LED light with an encapsulant including embedded light-storing phosphor particles, to be used in a Christmas or other holiday season light string.

FIG. 3 shows an LED light with an encapsulant including a layer of light-storing phosphor particles, to be used in a Christmas or other holiday season light string.

### DESCRIPTION

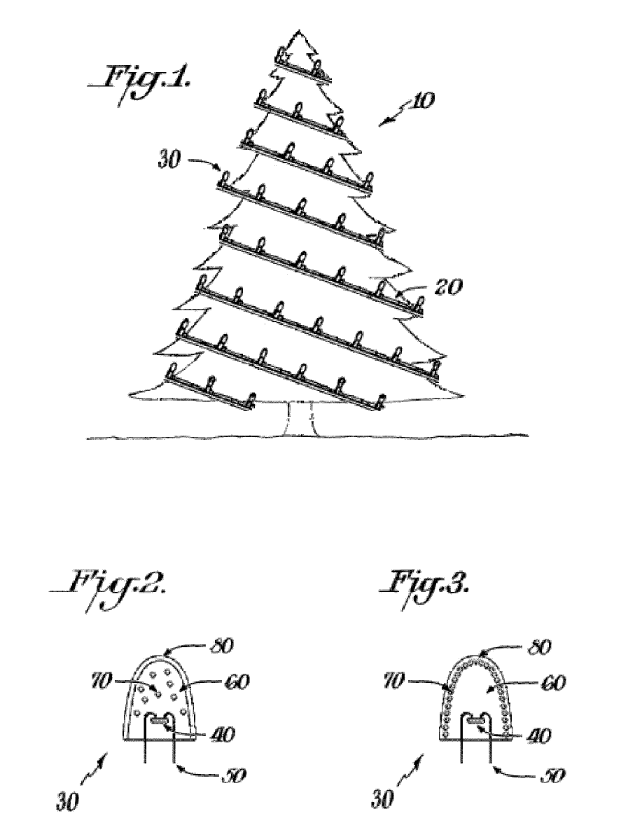

As shown in FIG. 1, a Christmas tree 1 0 is draped with a holiday season light string 20 having lighting elements 30. A typical LED light string would be a 120 VAC driven, series-wired light string 20 of low voltage, e.g., 2-3.5V/20 mA, LED lights 30.

The light string 20 is provided with phosphorescent, after glow characteristics by use of UV or near UV LED lights 30 to energize light-storing phosphor particles. As shown in FIG. 2, an LED light 30 includes an LED circuit 40 having electrical terminals 50. The LED light 30 includes an encapsulant 60, embedded light-storing phosphor particles 70, and a protective coating or shell 80. The LED light shown in FIG. 3 is similar except that light-storing phosphor particles 70 are in a layer or coating on the encapsulant 60.

When the LED light 30 is activated and emitting blue or UV rays, the light-storing phosphor particles 70 charge and store this energy. When power is removed from the LED light 30, it is deactivated and no longer emits the blue or UV rays. The light-storing phosphor particles 70 at this point are highly activated and emit light at a lower energy wavelength according to their inherent characteristics. The frequency, duration and intensity of the emitted after glow light or phosphorescence are a function of the selected light-storing phosphor materials and how they are impurity doped. With high luminance after glow materials, a Christmas tree or other decorations decorated with such lamp LED light structures will “glow” for hours after being turned off electrically.

Near UV emitting LED light circuits 40, e.g., GaN or InGaN based LEDs, are generally available. The illustrated encapsulant 60 is a light conducting material such as epoxy, polymer, plastic or resin. To diffuse or more evenly disperse emitted light, the illustrated encapsulant 60 is translucent or contains a light diffuser or light dispersant, e.g., light-scattering particles applied to or embedded in the encapsulant 60. Light-storing phosphor particles 70 can be made of light-storing phosphorescent materials such as copper activated zinc sulphide, but for long after glow effects, long persistence alkaline earth metal oxide aluminates doped with rare earth ions are used, such as a, e.g., europium doped, strontium oxide aluminate compound.

The light-storing phosphor particles 70 are embedded in the encapsulant 60 shown in FIG. 2, or included in one or more layers or coatings, e.g., painted on, deposited, or otherwise applied as a coating or film as shown in FIG. 3. Different colors of emitted or after glow light are achieved by adding or using pigment or phosphor pigment particles embedded in, applied on or otherwise included in the encapsulant 60. For example, different colors are achieved through selection of base compounds and dopants for the light-storing phosphor particles 70, or by adding other pigment particles, in a manner that is well known. See, e.g., U.S. Pat. No. 6,809,471 to Setlur et al. The illustrated optional shell 80 is made of a clear or translucent plastic, glass or similar protective light conducting material.

While the foregoing description presents the invention in general terms and in terms of specific examples, many variations are possible which are not described here. All such variations of the invention are also within the scope of the following claims.

What is claimed is:

1. A method of providing afterglow in a lighting element in a holiday season light string, comprising steps of having an LED lighting element in the light string, and enabling receipt of emitted light by a light conducting encapsulant for the LED lighting element, said encapsulant containing light-storing phosphor particles, whereby when the lighting element is on, light energy is stored in the light-storing phosphor particles, providing an afterglow when the lighting element is turned off in the light string.

2. The method of claim 1 where said LED lighting element emits UV light.

3. The method of claim 1 where said LED lighting element emits blue light.

4. The method of claim 1 where said encapsulant contains pigment particles.

5. The method of claim 1 where said phosphor particles comprise a rare-earth metal doped compound of alkaline-earth metal oxide aluminate.

6. The method of claim 1 in which said phosphor particles comprise a europium doped compound of strontium oxide aluminate.

7. The method of claim 1 where said encapsulant contains a light diffuser.

8. The method of claim 1 in which said encapsulant comprises separate layers and said pigment particles and said phosphor particles are contained in different layers.

9. A method of providing afterglow in lighting elements in a holiday season light string, comprising steps of having multiple LED lighting elements in the light string, and enabling receipt of emitted light by a light conduction encapsulant for each LED lighting element, said encapsulant containing a light diffuser and light-storing phosphor particles, whereby when the LED lighting elements are on, light energy is stored in the phosphor particles, providing an afterglow when the LED lighting elements are turned off.

10. The method of claim 9 where said LED lighting elements emit UV light.

11. The method of claim 9 where said LED lighting elements emit blue light.

12. The method of claim 9 where said encapsulant contains pigment particles.

13. The method of claim 9 where said phosphor particles comprise a rare-earth metal doped compound of alkaline-earth metal oxide aluminate.

14. The method of claim 9 in which said phosphor particles comprise a europium doped compound of strontium oxide aluminate.

15. The method of claim 9 in which said encapsulant comprises separate layers and said pigment particles and said phosphor particles are contained in different layers.
